(19) United States
(12) Patent Application Publication
(10) Pub. No.: US 2010/0033557 A1
(43) Pub. Date: Feb. 11, 2010

(54) Stereoscopic image display and method for producing the same

(75) Inventors: Hiromichi Abe, Kanagawa (JP); Hiroshi Ohno, Tokyo (JP); Hideo Niyomura, Gifu (JP); Joji Karasawa, Kanagawa (JP); Osamu Horie, Kanagawa (JP); Masamichi Okada, Kanagawa (JP); Atsushi Sakata, Kanagawa (JP); Takayuki Kobayashi, Tokyo (JP); Takanobu Suto, Tochigi (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/460,824

(22) Filed: Jul. 24, 2009

(30) Foreign Application Priority Data
Jul. 28, 2008 (JP) P2008-193102
Nov. 6, 2008 (JP) P2008-285021
Nov. 6, 2008 (JP) P2008-285022
Apr. 24, 2009 (JP) P2009-105887

(51) Int. Cl. H04N 13/04; H01J 9/00

(52) U.S. Cl. 348/58; 445/24

(57) ABSTRACT

A stereoscopic image display includes an image display panel that displays right-eye images and left-eye images in a regularly mixed pattern in a plane; a retarder disposed on an image output side of the image display panel and including right-eye-image display portions, corresponding to the right-eye images, and left-eye-image display portions, corresponding to the left-eye images, that cause polarization so that the right-eye images and the left-eye images have different polarization states; a polarizer disposed between the image display panel and the retarder; and a light-shielding layer disposed between the image display panel and the polarizer so as to correspond to regions including boundaries between the right-eye-image display portions and the left-eye-image display portions of the retarder.

### CROSS-REFERENCE TO RELATED APPLICATION

The present application claims priority from Japanese Patent Application No. JP 2008-193102 filed in the Japanese Patent Office on Jul. 28, 2008, Japanese Patent Application No. JP 2008-285022 filed in the Japanese Patent Office on Nov. 6, 2008, Japanese Patent Application No. JP 2008-285021, filed in the Japanese Patent Office on Nov. 6, 2008 and Japanese Patent Application No. JP 2009-105887 filed in the Japanese Patent Office on Apr. 24, 2009, the entire contents of which are incorporated herein by reference.

### BACKGROUND OF THE INVENTION

1. Field of the Invention

The present invention relates to stereoscopic image displays that display stereoscopic images using right-eye images and left-eye images and methods for producing such stereoscopic image displays.

2. Description of the Related Art

An example of a stereoscopic image display for displaying a stereoscopic image is shown in FIG. 14 (see, for example, Japanese Unexamined Patent Application Publication No. 2002-196281 (Patent Document 1)). The stereoscopic image display shown includes an image display panel 51, such as a liquid crystal panel, and a retarder 52 disposed on the image output side thereof and is configured so that the viewer can view a display output through polarized glasses 53. More specifically, the image display panel 51 displays right-eye images R and left-eye images L in a regularly mixed pattern in a plane, for example, such that the right-eye images R and the left-eye images L alternate in horizontal lines. The retarder 52 includes right-eye-image display portions 52R, corresponding to the right-eye images R, and left-eye-image display portions 52L, corresponding to the left-eye images L, arranged such that they alternate in horizontal lines. The retarder 52 is configured so that the right-eye-image display portions 52R and the left-eye-image display portions 52L achieve different polarization states, for example, so that the right-eye-image display portions 52R achieve a linear polarization pointing in one direction (for example, upward to the right) whereas the left-eye-image display portions 52L achieve a polarization perpendicular thereto by rotation through 90° (for example, upward to the left). In front of the image display panel 51 and the retarder 52, the viewer wears the polarized glasses 53, which have different polarization angles matching the left-eye images L and the right-eye images R on the left and right sides. The viewer thus separately perceives the right-eye images R on the right eye and the left-eye images L on the left eye. That is, through a right-eye lens 53R whose polarization angle points upward to the right, the viewer does not see the left-eye images L in the even-numbered lines because the polarization angle thereof is rotated through 90° so as to point upward to the left by the left-eye-image display portions 52L of the retarder 52; the viewer sees only the right-eye images R in the odd-numbered lines because the polarization angle thereof matches that of the right-eye lens 53R. On the other hand, through a left-eye lens 53L whose polarization angle points upward to the left, the viewer does not see the right-eye images R in the odd-numbered lines because the polarization angle thereof is rotated through 90° so as to point upward to the right by the right-eye-image display portions 52R of the retarder 52; the viewer sees only the left-eye images L in the even-numbered lines because the polarization angle thereof matches that of the left-eye lens 53L. In addition to the configuration described above, there are various configurations of stereoscopic image displays for separately displaying left-eye images and right-eye images to be combined into a stereoscopic image through polarized glasses.

Such stereoscopic image displays often face the problem of crosstalk. Crosstalk is a phenomenon that decreases the sharpness of an image perceived by the viewer and therefore causes problems such as a degraded stereoscopic effect. This phenomenon results from transmission of the right-eye images R through the left-eye-image display portions 52L or transmission of the left-eye images L through the right-eye-image display portions 52R when, for example, the viewer views the image not in front but in an oblique direction.

Some stereoscopic image displays include a light-shielding layer for blocking light at the boundaries between the right-eye-image display portions 52R and the left-eye-image display portions 52L of the retarder 52 (see, for example, Japanese Unexamined Patent Application Publication No. 2002-185983 (Patent Document 2)). More specifically, for example, if the right-eye-image display portions 52R and the left-eye-image display portions 52L alternate in horizontal lines, a striped light-shielding layer is provided only in regions of predetermined width including the boundaries between the display portions 52R and 52L. The light-shielding layer may be formed by providing a black material functioning to block light on a surface of the retarder 52. This light-shielding layer blocks light to prevent transmission of the right-eye images R through the left-eye-image display portions 52L or transmission of the left-eye images L through the right-eye-image display portions 52R even if, for example, the viewer views the image in an oblique direction. The light-shielding layer can thus prevent crosstalk.

### SUMMARY OF THE INVENTION

A light-shielding layer with a larger pattern width is preferable in view of preventing crosstalk. That is, a light-shielding layer with an extremely small pattern width may insufficiently block crosstalk light.

A light-shielding layer with an extremely large pattern width, however, may decrease the luminance of a displayed image because of decreased transmitted light.

The pattern width of the light-shielding layer should therefore be determined so that crosstalk can be prevented while minimizing the decrease in the luminance of a displayed image.

According to the technique discussed in Patent Document 2, the light-shielding layer is directly formed on the front or rear of the retardation film. This technique is not necessarily successful in addressing the case where there is a tradeoff between the prevention of crosstalk and the prevention of the decrease in the luminance of a displayed image.

Accordingly, it is desirable to provide a stereoscopic image display capable of reliably preventing crosstalk using a light-shielding layer while minimizing a decrease in the luminance of a displayed image and also to provide a method for producing such a stereoscopic image display.

A stereoscopic image display according to an embodiment of the present invention includes an image display panel that displays right-eye images and left-eye images in a regularly mixed pattern in a plane; a retarder disposed on an image output side of the image display panel and including right-eye-image display portions, corresponding to the right-eye images, and left-eye-image display portions, corresponding to the left-eye images, that cause polarization so that the right-eye images and the left-eye images have different polarization states; a polarizer disposed between the image display panel and the retarder; and a light-shielding layer disposed between the image display panel and the polarizer so as to correspond to regions including boundaries between the right-eye-image display portions and the left-eye-image display portions of the retarder.

The above stereoscopic image display has the light-shielding layer on the side of the polarizer opposite the image display panel. In this case, the light-shielding layer is disposed closer to the image display panel than in the case where the light-shielding layer is disposed on the image output side (farther away from the image display panel) of the polarizer, for example, in the case where the light-shielding layer is directly formed on a surface of the retarder. The light-shielding layer can therefore prevent crosstalk with a smaller pattern width for the same viewing angle than in the case where the light-shielding layer is disposed on the image output side of the polarizer.

Thus, because the pattern width of the light-shielding layer can be made smaller than in the case where the light-shielding layer is disposed on the image output side of the polarizer, the above stereoscopic image display can prevent crosstalk while minimizing a decrease in the luminance of a displayed image.

### BRIEF DESCRIPTION OF THE DRAWINGS

FIG. 1 is a schematic diagram of a first exemplary structure of a stereoscopic image display according to an embodiment of the present invention;

FIG. 2 is a schematic diagram of a second exemplary structure of the stereoscopic image display according to the embodiment of the present invention;

FIGS. 3A and 3B are schematic diagrams showing a specific example of a light-shielding-layer providing step in a method for producing the stereoscopic image display according to the embodiment of the present invention;

FIG. 4 is a schematic diagram showing a first example of a positioning step in the method for producing the stereoscopic image display according to the embodiment of the present invention;

FIG. 5 is a schematic diagram showing a second example of the positioning step in the method for producing the stereoscopic image display according to the embodiment of the present invention;

FIGS. 6A to 6C are graphs, a table, and diagrams showing a specific example of the relationship between the hardness of tackiness agents and the holding force of tackiness agent layers for bonding agent layers used in the stereoscopic image display according to the embodiment of the present invention;

FIG. 7 is a set of graphs showing a specific example of the elasticity and viscosity of tackiness agents for the bonding agent layers used in the stereoscopic image display according to the embodiment of the present invention;

FIGS. 8A and 8B are a table and a diagram, respectively, showing a specific example of the creep rate of the bonding agent layers used in the stereoscopic image display according to the embodiment of the present invention;

FIGS. 9A and 9B are a diagram and a graph, respectively, showing a specific example of press bonding using a bonding roller in a bonding step in the method for producing the stereoscopic image display according to the embodiment of the present invention;

FIGS. 10A and 10B are schematic diagrams showing the advantages of the stereoscopic image display according to the embodiment of the present invention;

FIG. 11 is another schematic diagram showing the advantages of the stereoscopic image display according to the embodiment of the present invention;

FIG. 12 is a graph showing the advantages of the stereoscopic image display according to the embodiment of the present invention;

FIG. 13 is another graph showing the advantages of the stereoscopic image display according to the embodiment of the present invention; and

FIG. 14 is a schematic diagram of a basic exemplary structure of a stereoscopic image display in the related art.

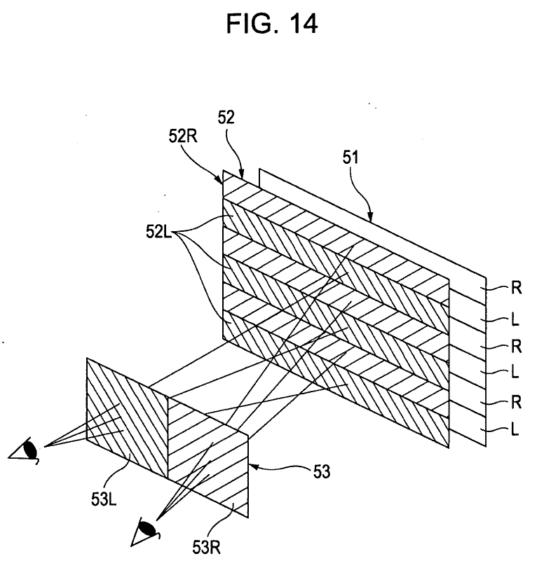

### DESCRIPTION OF THE PREFERRED EMBODIMENTS

An embodiment of the present invention will now be described. The description will be presented in the following order:

1. Exemplary structures of stereoscopic image display (first and second exemplary structures)

2. Method for producing stereoscopic image display (annealing step, light-shielding-layer providing step, positioning step, and bonding step)

3. Advantages of embodiment

### 1. Exemplary Structures of Stereoscopic Image Display

First, exemplary structures of a stereoscopic image display according to this embodiment will be described.

### 1-1. First Exemplary Structure

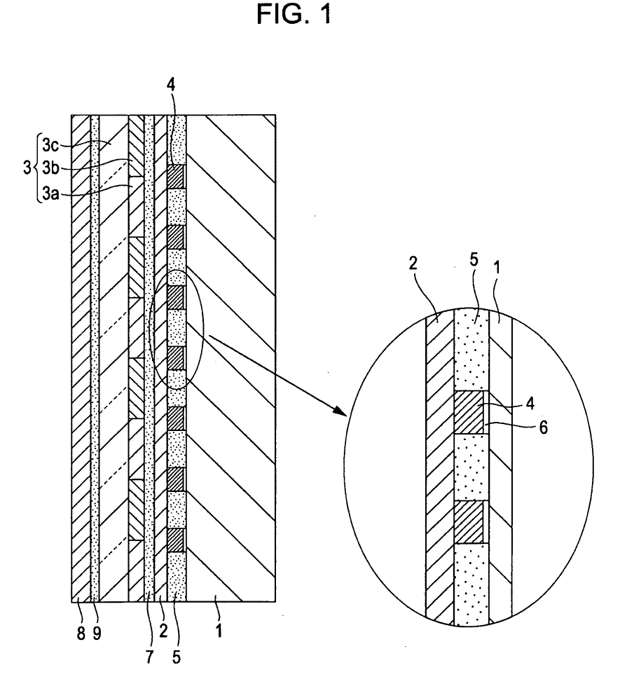

FIG. 1 is a schematic diagram of a first exemplary structure of the stereoscopic image display according to this embodiment.

The stereoscopic image display shown includes an image display panel 1, a polarizer 2, a retarder 3, a light-shielding layer 4, a first bonding agent layer 5, air layers 6, a second bonding agent layer 7, an antireflection film 8, and a third bonding agent layer 9.

The image display panel 1 is, for example, a liquid crystal panel and displays right-eye images and left-eye images in a regularly mixed pattern in a plane, for example, such that the right-eye images and the left-eye images alternate in horizontal lines. Although the right-eye images and the left-eye images alternate in horizontal lines in this example, any other pattern in which they are regularly mixed in a plane may instead be used. In addition, the image display panel 1 does not have to be a liquid crystal panel, but may be another display device such as an electroluminescent (EL) display panel.

The polarizer 2 is disposed on the image output side of the image display panel 1 between the image display panel 1 and the retarder 3 and, of light coming from the image display panel 1, transmits only light oscillating in a predetermined direction. The term “image output side” herein refers to the panel side on which an image is displayed, specifically, the side facing the viewer viewing the image. For example, if the image display panel 1 is a transmissive liquid crystal panel, the polarizer 2 is paired with another polarizer (not shown) disposed opposite the polarizer 2 with the image display panel 1 therebetween, thus forming a crossed-nicol configuration.

The retarder 3 includes right-eye-image display portions 3a corresponding to the right-eye images and left-eye-image display portions 3b corresponding to the left-eye images. As with the right-eye images and the left-eye images on the image display panel 1, the right-eye-image display portions 3a and the left-eye-image display portions 3b are arranged on the image output side of the image display panel 1 in a regularly mixed pattern in a plane (for example, such that they alternate in horizontal lines). More specifically, the retarder 3 includes a support substrate 3c, formed of glass or a nonbirefringent film, on which a retardation layer is formed. The retardation layer includes portions that achieve a polarization state corresponding to the right-eye images and portions that achieve a polarization state corresponding to the left-eye images; they function as the right-eye-image display portions 3a and the left-eye-image display portions 3b. That is, the retarder 3 is configured so that the right-eye-image display portions 3a and the left-eye-image display portions 3b achieve different polarization states.

Specifically, for example, the retarder 3 used may be one in which the right-eye-image display portions 3a and the left-eye-image display portions 3b have orthogonal polarization directions and alternate on a support substrate 3c with a thickness of about 0.7 mm so as to agree with the vertical pitch of the horizontal lines of the image display panel 1. In addition, for example, the retarder 3 used may be one prepared by laminating a nonbirefringent triacetyl cellulose (TAC) film and a stretched PVA film with a retardation function on the support substrate 3c with an adhesive therebetween, eliminating the retardation function in regions other than linear regions where a resist is applied so that the right-eye-image display portions 3a and the left-eye-image display portions 3b are formed in an alternate pattern, and laminating a nonbirefringent protective film on the side on which the resist is applied before bonding the retardation film to the image display panel 1. The retarder 3 used may also be one having a uniaxially oriented liquid crystal polymer layer on the support substrate 3c.

The light-shielding layer 4 is provided so as to correspond only to regions including the boundaries between the right-eye-image display portions 3a and the left-eye-image display portions 3b of the retarder 3 to prevent crosstalk. More specifically, for example, if the right-eye-image display portions 3a and the left-eye-image display portions 3b alternate in horizontal lines, the light-shielding layer 4 is provided in a striped pattern only in regions of predetermined width including the boundaries between the display portions 3a and 3b. The light-shielding layer 4 may be formed by selectively providing a black material, such as carbon, functioning to block light in a striped pattern so that the height thereof is, for example, about 10 to 15 μm.

The light-shielding layer 4, which is provided so as to correspond to the regions including the boundaries between the right-eye-image display portions 3a and the left-eye-image display portions 3b of the retarder 3, is positioned not on a surface of the retarder 3 but on the side of the polarizer 2 facing the image display panel 1.

The first bonding agent layer 5 is disposed between the image display panel 1 and the polarizer 2 to bond them together. That is, because the light-shielding layer 4 is provided on the surface of the polarizer 2 opposite the image display panel 1, the first bonding agent layer 5 is disposed between the image display panel 1 and the surface of the polarizer 2 on which the light-shielding layer 4 is provided.

More specifically, the first bonding agent layer 5 is disposed between the image display panel 1 and the surface of the polarizer 2 on which the light-shielding layer 4 is provided so as to be excluded between the top surface of the light-shielding layer 4 and the image display panel 1. Thus, the first bonding agent layer 5 is excluded and therefore not disposed between the top surface of the light-shielding layer 4 and the image display panel 1.

It is preferable to exclude the first bonding agent layer 5 between the top surface of the light-shielding layer 4 and the image display panel 1 for the reason described later. The first bonding agent layer 5, however, does not necessarily have to be excluded between the top surface of the light-shielding layer 4 and the image display panel 1; it may be disposed therebetween so as to cover ridges and grooves formed by the light-shielding layer 4. Conversely, it is also possible to dispose the first bonding agent layer 5 only between the top surface of the light-shielding layer 4 and the image display panel 1, thus leaving empty spaces in regions where the light-shielding layer 4 is not provided.

The term “bonding agent layer” herein refers to a layer formed of a bonding agent. The term “bonding agent” herein refers to a material disposed between members to bond them together and specifically encompasses adhesives and tackiness agents. Hence, the term “bonding agent layer” encompasses layers formed of adhesives and layers formed of tackiness agents.

In the stereoscopic image display according to this embodiment, for the reason described later, the first bonding agent layer 5 is formed of a transparent gelatinous acrylic tackiness agent and has a thickness of 25 to 100 μm. In addition, the hardness of the tackiness agent is more than 0 μN and not more than 350,000 μN, and the holding force after bonding is 8 to 20 N/20 mm at 40° C.

In the stereoscopic image display according to this embodiment, additionally, the first bonding agent layer 5 may satisfy the following conditions in addition to, or instead of, the conditions described above. That is, for the reason described later, the first bonding agent layer 5 may be formed of a transparent gelatinous acrylic tackiness agent with a storage stiffness of more than 0 Pa and not more than 70,000 Pa and a loss stiffness of more than 0 Pa and not more than 20,000 Pa at 30° C. to 70° C. Satisfying these conditions allows the first bonding agent layer 5 to have a creep rate of 0.3 mm or less.

The term “tackiness agent” herein refers to a semisolid material that initially has high viscosity and low elastic modulus and that does not change its state after bonding, in other words, that can be used without a curing step.

The air layers 6 are formed by excluding the first bonding agent layer 5 between the top surface of the light-shielding layer 4 and the image display panel 1. That is, the air layers 6 are formed of spaces not filled with the first bonding agent layer 5.

The second bonding agent layer 7 is disposed between the polarizer 2 and the retarder 3 to bond them together.

As with the first bonding agent layer 5, the second bonding agent layer 7 is formed of a transparent gelatinous acrylic tackiness agent and has a thickness of 25 to 100 μm. In addition, the hardness of the tackiness agent is more than 0 pN and not more than 350,000 pN, and the holding force after bonding is 8 to 20 N/20 mm at 40° C.

In addition, as with the first bonding agent layer 5, the second bonding agent layer 7 may be formed of a transparent gelatinous acrylic tackiness agent with a storage stiffness of more than 0 Pa and not more than 70,000 Pa and a loss stiffness of more than 0 Pa and not more than 20,000 Pa at 30° C. to 70° C. Satisfying these conditions allows the second bonding agent layer 7 to have a creep rate of 0.3 mm or less.

The antireflection film 8 is disposed so as to cover the image output side of the retarder 3. The antireflection film 8 prevents light reflection at the image output side to improve light transmittance.

The third bonding agent layer 9 is disposed to bond the antireflection film 8 to the retarder 3 (more specifically, to the support substrate 3c of the retarder 3) and may be formed of, for example, an adhesive or a tackiness agent.

In the first exemplary structure of the stereoscopic image display, the retarder 3 is disposed on the image output side of the polarizer 2 with the second bonding layer 7 therebetween to create a stereoscopic image. The retarder 3 includes the right-eye-image display portions 3a corresponding to the right-eye images and the left-eye-image display portions 3b corresponding to the left-eye images, and they achieve different polarization states.

Hence, by wearing polarized glasses that have different polarization angles matching the left-eye images and the right-eye images on the left and right sides, the viewer separately perceives the right-eye images on the right eye and the left-eye images on the left eye. The viewer can thus view a stereoscopic image.

In the first exemplary structure of the stereoscopic image display, additionally, the light-shielding layer 4 is provided between the image display panel 1 and the retarder 3, more specifically, between the image display panel 1 and the polarizer 2, so as to correspond to the regions including the boundaries between the right-eye-image display portions 3a and the left-eye-image display portions 3b. The light-shielding layer 4 blocks light to prevent transmission of the right-eye images through the left-eye-image display portions 3b or transmission of the left-eye images through the right-eye-image display portions 3a even if, for example, the viewer views the image in an oblique direction. The light-shielding layer 4 can thus prevent crosstalk.

In the first exemplary structure of the stereoscopic image display, additionally, the image display panel 1 and the polarizer 2 are bonded together with the first bonding agent layer 5 therebetween, and the polarizer 2 and the retarder 3 are bonded together with the second bonding agent layer 7 therebetween. That is, the portions bonded together with the first bonding agent layer 5 and the second bonding agent layer 7 overlap an image display region of the image display panel 1. Unlike bonding only outside the image display region of the image display panel 1, the bonding in this example does not result in insufficient adhesion near the center of the image display region or variations in the distances between the components. This avoids, for example, the moire phenomenon and Newton's rings (interference fringes), which can degrade the quality of a displayed image.

In the bonding using the first bonding agent layer 5, additionally, even though the ridges and grooves formed by the light-shielding layers 4 are present between the image display panel 1 and the polarizer 2, the first bonding agent layer 5 is disposed in the grooves where the light-shielding layer 4 is not provided, that is, the regions where light is transmitted, so as to follow the shape of the grooves. In other words, the first bonding agent layer 5 fills the grooves, thus leaving no air layer in the grooves. This prevents degradation of the quality of a displayed image due to light refraction at air layers.

On the other hand, if the first bonding agent layer 5 is provided so as to be excluded between the top surface of the light-shielding layer 4 and the image display panel 1, the air layers 6, that is, spaces not filled with the first bonding agent layer 5, are present between the top surface of the light-shielding layer 4 and the image display panel 1. These air layers 6 function to release strain that can occur during the bonding, thus alleviating unevenness in the in-plane distribution of bonding stress after the bonding. In addition, because the air layers 6 are present between the top surface of the light-shielding layer 4 and the image display panel 1, where light is blocked by the light-shielding layer 4, the air layers 6 do not degrade the quality of a displayed image, unlike those remaining in the grooves where the light-shielding layer 4 is not provided.

Thus, if the first bonding agent layer 5 is provided so as to be excluded between the top surface of the light-shielding layer 4 and the image display panel 1, the first bonding agent layer 5, despite the ridges and grooves formed by the light-shielding layer 4, inhibits degradation of image quality due to light refraction by eliminating unwanted air layers and inhibits degradation of image quality due to unevenness in in-plane stress distribution by leaving the air layers 6. This allows the image display panel 1 and the polarizer 2 to be successfully bonded together.

In addition, if the first bonding agent layer 5 and the second bonding agent layer 7 are formed of a tackiness agent, the cost of the tackiness agent itself is lower than that of, for example, an adhesive. In addition, because a tackiness agent does not cure as does an adhesive, the first bonding agent layer 5 and the second bonding agent layer 7 themselves function to buffer an external load. This prevents scattering of pieces of a glass substrate broken by a load on the image display panel 1 and therefore eliminates the use of, for example, a protective film, thus reducing the number of components used. In addition, unlike bonding using an adhesive or an UV-curable resin, components bonded together with a tackiness agent can be separated when some problem occurs and can be bonded again afterwards, thus facilitating the bonding procedure. In addition, tackiness agents are expected to be less environmentally harmful than, for example, adhesives containing volatile solvents.

### 1-2. Second Exemplary Structure

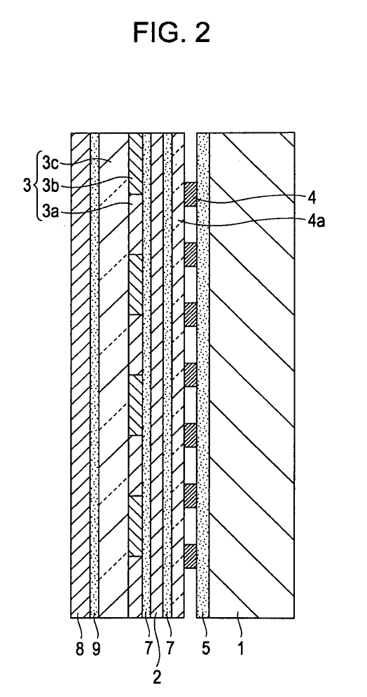

FIG. 2 is a schematic diagram of a second exemplary structure of the stereoscopic image display according to this embodiment.

The stereoscopic image display shown differs from the first exemplary structure described above (see FIG. 1) in that a substrate sheet 4a is disposed between the polarizer 2 and the light-shielding layer 4.

The substrate sheet 4a is formed of, for example, a TAC film and has the light-shielding layer 4 on a surface thereof. In the production of the stereoscopic image display including the substrate sheet 4a, the light-shielding layer 4 is not directly formed on the surface of the polarizer 2 but is formed on the surface of the substrate sheet 4a, which is then bonded to the surface of the polarizer 2. The light-shielding layer 4 can therefore be more easily formed than, for example, in the case where the light-shielding layer 4 is directly formed on the surface of the polarizer 2.

The substrate sheet 4a on which the light-shielding layer 4 is formed and the polarizer 2 are bonded together with the second bonding agent layer 7 therebetween, as are the polarizer 2 and the retarder 3, with the light-shielding layer 4 facing the image display panel 1.

On the other hand, the substrate sheet 4a and the image display panel 1 are bonded together with the first bonding agent layer 5 therebetween, as in the first exemplary structure. The first bonding agent layer 5 is formed with a uniform thickness over the entire region of the panel surface, including the regions between the top surface of the light-shielding layer 4 and the image display panel 1. Accordingly, spaces not filled with the first bonding agent layer 5 are present between the image display panel 1 and the substrate sheet 4a in regions other than the top surface of the light-shielding layer 4 (regions where the light-shielding layer 4 is not provided).

It is preferable to form the first bonding agent layer 5 with a uniform thickness between the image display panel 1 and the substrate sheet 4a so that spaces not filled with the first bonding agent layer 5 remain in the regions where the light-shielding layer 4 is not provided, for the reason described later. The spaces, however, do not necessarily have to be present; that is, the first bonding agent layer 5 may be formed between the image display panel 1 and the substrate sheet 4a so as to cover the ridges and grooves formed by the light-shielding layer 4. Conversely, it is also possible to form the first bonding agent layer 5 between the image display panel 1 and the substrate sheet 4a so as to be excluded between the top surface of the light-shielding layer 4 and the image display panel 1, thus leaving the air layers 6 between the top surface of the light-shielding layer 4 and the image display panel 1.

In the second exemplary structure of the stereoscopic image display, the spaces not filled with the first bonding agent layer 5 between the image display panel 1 and the substrate sheet 4a alleviate unevenness in the in-plane distribution of bonding stress after the bonding. For example, even if the ridges and grooves formed by the light-shielding layer 4 cause waviness in a plane constituted by the surface bonded to the image display panel 1, that is, the top surface of the light-shielding layer 4, the above spaces function to release strain that can occur during the bonding. This alleviates the unevenness in the in-plane distribution of bonding stress.

In addition, because the first bonding agent layer 5 is provided at least on the top surface of the light-shielding layer 4, that is, the top surfaces of the ridges, a procedure for providing the first bonding agent layer 5 between the image display panel 1 and the substrate sheet 4a and bonding them together using the first bonding agent layer 5 is simpler than that carried out so as not to leave spaces not filled with the first bonding agent layer 5. That is, the bonding procedure can be easily carried out by, for example, laminating a sheet-shaped first bonding agent layer 5.

The second exemplary structure is identical to the first exemplary structure in the points other than those described above.

### 2. Method for Producing Stereoscopic Image Display

Next, a method for producing the stereoscopic image display thus configured will be described.

The method for producing the stereoscopic image display includes at least an annealing step, a light-shielding-layer providing step, a positioning step, and a bonding step.

These steps will be sequentially described below.

### 2-1. Annealing Step

As described above, the stereoscopic image display includes the retarder 3, which is formed of a material originally containing water and which tends to absorb moisture in air. If the retarder 3 is bonded in that state with the top and bottom surfaces thereof held and sealed between impervious, optically transparent materials such as glass substrates in the production of the stereoscopic image display, the following problem may occur.

For example, the stereoscopic image display can be transported across the equator by ship after shipment from a manufacturing plant as a finished product. In this case, the temperature around the product may reach 60° C. to 70° C. If the stereoscopic image display is exposed to such a high-temperature environment for a certain period of time or more, the retarder 3 possibly release gases such as those of water and acetic acid to generate bubbles measuring about 50 to 200 μm in the stereoscopic image display. With the top and bottom surfaces of the retarder 3 sealed, these bubbles are trapped. This may impair the product quality of the stereoscopic image display.

In the production of the stereoscopic image display, therefore, the annealing step for the retarder 3 is carried out before bonding the retarder 3.

In the annealing step, the retarder 3 is subjected to heat treatment with at least one surface of the retarder 3, more specifically, the surface on which the right-eye-image display portions 3a and the left-eye-image display portions 3b are formed, being unsealed and open to the atmospheric environment.

The heat treatment is performed at a predetermined temperature for a predetermined period of time. Specifically, given that the heat resistance of the retarder 3 is up to about 100° C. to 120° C., the heat treatment may be performed at, for example, 40° C. to 80° C., preferably about 70° C., for one hour to three days, preferably about 48 hours.

As for the other conditions, the heat treatment may be performed according to a common technique.

After the annealing step including the heat treatment described above, generation of bubbles from the retarder 3, which can impair product quality, can be inhibited even if the stereoscopic image display is exposed to a high-temperature environment for a certain period of time or more.

As a specific example, a stereoscopic image display subjected to an annealing step including heat treatment at 70° C. for 24 hours and a stereoscopic image display produced without the annealing step were examined by exposing the finished products to an environment at 70° C. for 48 hours and counting the number of bubbles visible in a panel region measuring 14 cm×35 cm. According to the results of the experiment, the product produced without the annealing step contained 61 bubbles, whereas the product subjected to the annealing step contained only two bubbles.

Thus, the annealing step significantly reduces the number of bubbles generated from the retarder 3, which can impair product quality.

### 2-2. Light-Shielding-Layer Providing Step

As described above, the stereoscopic image display includes the light-shielding layer 4. In the process of producing the stereoscopic image display, therefore, the light-shielding-layer providing step is carried out to provide the light-shielding layer 4.

The case where the light-shielding layer 4 in the first exemplary structure described above is provided by transfer will be described here as an example.

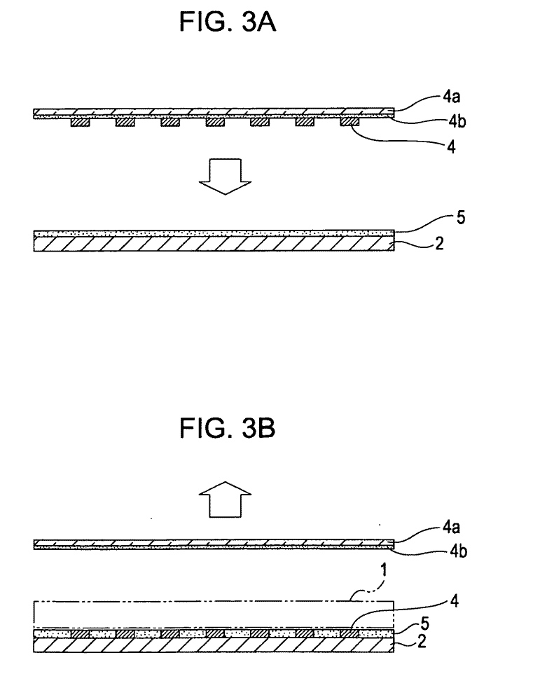

FIGS. 3A and 3B are schematic diagrams showing a specific example of the light-shielding-layer providing step.

In the light-shielding-layer providing step, first, the polarizer 2 is prepared, as shown in FIG. 3A. For example, if the polarizer 2 is supplied as an assembly integrated with the image display panel 1, it may be prepared as a discrete component by separating it from the image display panel 1. After the polarizer 2 is prepared, the first bonding agent layer 5 is formed with a uniform thickness on the surface of the polarizer 2 on which the light-shielding layer 4 is to be provided (the surface opposite the image display panel 1).

On the other hand, the light-shielding layer 4 is formed on the surface of the substrate sheet 4a, which is, for example, a TAC film, with a tackiness agent layer 4b therebetween so that the light-shielding layer 4 can be separably bonded to the surface of the substrate sheet 4a. The tackiness agent layer 4b has a lower tackiness than the first bonding agent layer 5. A description of a specific method for forming the light-shielding layer 4 will be omitted here because it may be formed by a common technique such as photolithography.

After the first bonding agent layer 5 is formed on the polarizer 2 and the light-shielding layer 4 is formed on the substrate sheet 4a with the tackiness agent layer 4b therebetween, they are bonded together with the light-shielding layer 4 facing the first bonding agent layer 5. The laminate is then pressed on both sides so that the light-shielding layer 4 enters the first bonding agent layer 5.

After the bonding, as shown in FIG. 3B, the substrate sheet 4a is removed. Because the tackiness agent layer 4b on the substrate sheet 4a has a lower tackiness than the first bonding agent layer 5, the tackiness difference allows the light-shielding layer 4 to be transferred from the substrate sheet 4a onto the polarizer 2 when the substrate sheet 4a is removed. That is, the light-shielding layer 4 is fixed to the surface of the polarizer 2 with the first bonding agent layer 5.

Thus, the light-shielding layer 4 is provided on the polarizer 2 by transferring it onto the polarizer 2. The first bonding agent layer 5 fills the grooves formed by the light-shielding layer 4, that is, the regions where the light-shielding layer 4 is not provided and therefore light is transmitted. The first bonding agent layer 5 is not disposed on the top surface of the light-shielding layer 4 (the top surfaces of the ridges formed by the light-shielding layer 4) on the surface of the polarizer 2, and no tackiness agent layer 4b remains after the removal of the substrate sheet 4a.

In the light-shielding-layer providing step, as described above, the light-shielding layer 4, separably formed on the substrate sheet 4a, is provided on the surface of the polarizer 2 by transferring it from the substrate sheet 4a. This allows the light-shielding layer 4 to be more easily provided than direct formation of the light-shielding layer 4 on the surface of the polarizer 2.

Although the transfer of the light-shielding layer 4 from the substrate sheet 4a has been described here as an example, the light-shielding-layer providing step can also be carried out without transferring the light-shielding layer 4. For the second exemplary structure, for example, the light-shielding layer 4 may be provided on the surface of the polarizer 2 by forming the light-shielding layer 4 on the substrate sheet 4a and bonding it on the surface of the polarizer 2 together with the substrate sheet 4a with the second bonding agent layer 7 therebetween. Alternatively, instead of using the substrate sheet 4a, the light-shielding layer 4 may be directly formed on the surface of the polarizer 2 by a common technique such as photolithography.

Although the light-shielding-layer providing step has been exemplified here by the transfer of the light-shielding layer 4 from the substrate sheet 4a onto the discrete polarizer 2, the light-shielding layer 4 does not necessarily have to be transferred from the substrate sheet 4a onto the discrete polarizer 2. For example, the light-shielding layer 4 may be transferred from the substrate sheet 4a onto the polarizer 2 with the retarder 3 bonded thereto with the second bonding agent layer 7 therebetween. That is, either of the light-shielding-layer providing step and a second bonding step, described later, may be carried out earlier.

### 2-3. Positioning Step

In the production of the stereoscopic image display, the image display panel 1, the retarder 3, and the light-shielding layer 4 are accurately positioned relative to each other.

For example, if the image display panel 1 and the retarder 3 are not accurately positioned relative to each other, the right-eye-image display portions 3a and the left-eye-image display portions 3b may be misaligned to the right-eye images and the left-eye images, respectively. This can cause problems such as a decrease in the sharpness of an image perceived by the viewer and a degraded stereoscopic effect. For example, if high-definition (HD) signals are displayed on a 40-inch screen, each pixel line is an ultrafine line measuring about 500 μm vertically. Accordingly, if the permissible range of misalignment is less than 5%, the positioning is performed with a variation of less than about 25 μm.

On the other hand, for example, if the retarder 3 and the light-shielding layer 4 are not accurately positioned relative to each other, the light-shielding layer 4 may be misaligned to the regions including the boundaries between the right-eye-image display portions 3a and the left-eye-image display portions 3b. This can result in failure to prevent crosstalk and a decrease in the luminance of a displayed image due to decreased transmitted light.

In the production of the stereoscopic image display, therefore, the positioning step is carried out for planar positioning of the image display panel 1, the retarder 3, and the light-shielding layer 4 before bonding them together.

### 2-3-1. First Example of Positioning Step

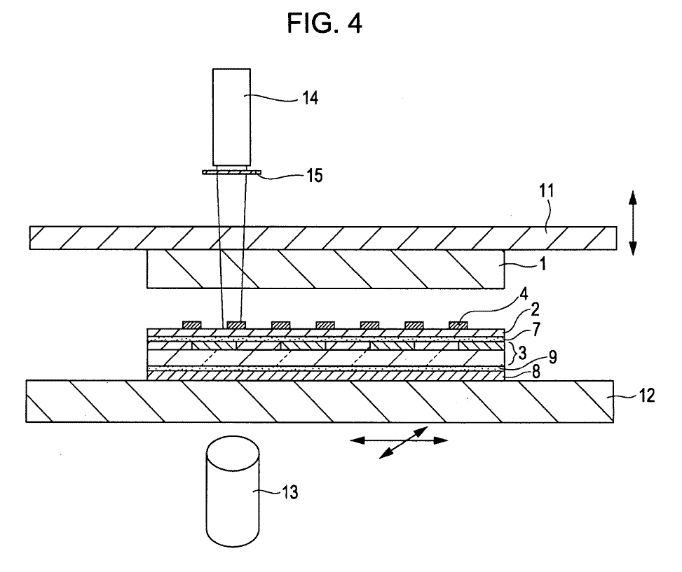

FIG. 4 is a schematic diagram showing a first example of the positioning step.

The example shown illustrates planar positioning of the image display panel 1 and a laminate including the light-shielding layer 4, the polarizer 2, the second bonding agent layer 7, the retarder 3, the third bonding agent layer 9, and the antireflection film 8 relative to each other. The planar positioning can be applied not only to the example shown, but also to the bonding of the light-shielding layer 4 and the polarizer 2 on the retarder 3 in the same manner.

In the planar positioning in the example shown, first, the image display panel 1 is supported on an upper seat 11 of a positioning apparatus, the laminate including the light-shielding layer 4 and the retarder 3 is supported on a lower seat 12 of the positioning apparatus, and they are positioned opposite each other. The supporting on the upper seat 11 and the lower seat 12 may be performed by a common technique such as vacuum attraction. At least one of the upper seat 11 and the lower seat 12 is slidable in the front-to-back and left-to-right directions or in the vertical direction in FIG. 4.

In the positioning apparatus, an imaging device 13, such as an image-processing camera for position detection, is disposed on the upper seat 11 side or the lower seat 12 side. A light source 14 for light irradiation is disposed on the side of the upper and lower seats 11 and 12 facing away from the imaging device 13. The light source 14 has a polarizer 15 for achieving a polarization state corresponding to either of the right-eye-image display portions 3a and the left-eye-image display portions 3b of the retarder 3.

The positioning apparatus may have a positioning system capable of optimum positioning by a bifocal depth-switching mechanism with a gap remaining with respect to a marking line added to an image from the imaging device 13.

In the planar positioning of the retarder 3, more specifically, in the planar positioning for bonding the light-shielding layer 4 and the polarizer 2 on the retarder 3, irradiation light from the light source 14 reaches the retarder 3 through the polarizer 15 disposed between the light source 14 and the laminate. The imaging device 13 acquires an image of the light transmitted through the retarder 3. Because the polarizer 15 polarizes the irradiation light from the light source 14, the light reaches the imaging device 13 either through the right-eye-image display portions 3a or through the left-eye-image display portions 3b while being blocked by the other display portions. According to imaging results from the imaging device 13, therefore, the boundaries between the right-eye-image display portions 3a and the left-eye-image display portions 3b of the retarder 3 are clearly recognized.

If the liquid crystal panel constituting the image display panel 1 operates in a normally black mode, it may be difficult to achieve light transmission through the liquid crystal panel with no voltage applied thereto by irradiation on one side with illumination light with an intensity similar to that of a backlight. In addition, it is not practical to apply a voltage to the liquid crystal panel for positioning.

Therefore, in the planar positioning of the image display panel 1, more specifically, in the planar positioning for bonding the laminate including the light-shielding layer 4 and the retarder 3 on the image display panel 1, the light source 14 emits irradiation light with a sufficient intensity to be transmitted through the normally-black-mode liquid crystal panel with no voltage applied thereto, that is, with the transmittance thereof minimized. Specifically, it is possible to emit irradiation light with a minimum intensity of, for example, more than 30,000 lux. The maximum intensity is preferably limited to such a level that the light has no adverse effect on, for example, liquid crystal molecules in the liquid crystal panel.

If the irradiation light emitted from the light source 14 has such an intensity, it reaches the imaging device 13 through the normally-black-mode liquid crystal panel with no voltage applied thereto. According to imaging results from the imaging device 13, therefore, it is possible to distinguish between, for example, regions where light is transmitted, including pixel regions, and regions covered with light-shielding films, including wiring regions, thus enabling the position of the image display panel 1 in a plane to be clearly recognized.

Thus, in the positioning step described above, the accuracy of positioning of the image display panel 1 and the laminate including the retarder 3 relative to each other can be improved from a variation of about 50 to 60 μm, which is typical in the related art, to a variation of about 25 μm.

### 2-3-2. Second Example of Positioning Step

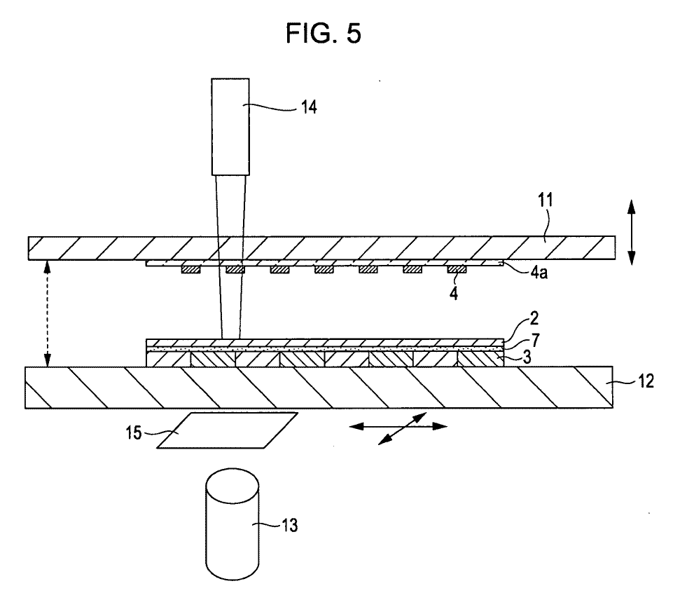

FIG. 5 is a schematic diagram showing a second example of the positioning step.

The example shown illustrates planar positioning, preceding the light-shielding-layer providing step, of the light-shielding layer 4 separably formed on the substrate sheet 4a and the polarizer 2 and the retarder 3 bonded together with the second bonding agent layer 7 therebetween relative to each other.

As described above, the retarder 3 and the light-shielding layer 4 are accurately positioned relative to each other. Specifically, if each pixel line is an ultrafine line measuring about 500 μm vertically, the permissible range of misalignment of the light-shielding layer 4 is typically less than 10%.

On the other hand, the substrate sheet 4a on which the light-shielding layer 4 is separably formed typically has low transparency because the light-shielding layer 4 is separably formed.

Therefore, if the polarizer 2 and the retarder 3 are bonded together before the light-shielding layer 4 is provided thereon by transfer, it may be difficult to achieve desired bonding with high positional accuracy using natural light transmitted through the polarizer 2 and the retarder 3 because of insufficient transmitted light in the regions including the boundaries between the right-eye-image display portions 3a and the left-eye-image display portions 3b of the retarder 3.

In the second example of the positioning step described herein, as shown in FIG. 5, first, the substrate sheet 4a on which the light-shielding layer 4 is separably formed is supported on an upper seat 11 of a positioning apparatus, the laminate of the polarizer 2 and the retarder 3 is supported on a lower seat 12 of the positioning apparatus, and they are positioned opposite each other with a minute gap remaining therebetween so that they do not stick to each other. The supporting on the upper seat 11 and the lower seat 12 may be performed by a common technique such as vacuum attraction. At least one of the upper seat 11 and the lower seat 12 is slidable in the front-to-back and left-to-right directions or in the vertical direction in FIG. 5.

In the positioning apparatus, an imaging device 13, such as an image-processing camera for position detection, is disposed on the lower seat 12 side. A light source 14 for light irradiation is disposed on the side of the upper and lower seats 11 and 12 facing away from the imaging device 13. A polarizer 15 for achieving a polarization state corresponding to either of the right-eye-image display portions 3a and the left-eye-image display portions 3b of the retarder 3 is disposed between the lower seat 12 and the imaging device 13.

The positioning apparatus has a positioning system capable of optimum positioning by a bifocal depth-switching mechanism with a gap remaining with respect to a marking line added to an image from the imaging device 13.

In the planar positioning, preceding the light-shielding-layer providing step, of the light-shielding layer 4 on the substrate sheet 4a and the polarizer 2 and the retarder 3 bonded together relative to each other, irradiation light from the light source 14 is sequentially transmitted through the substrate sheet 4a and the retarder 3 to reach the imaging device 13 through the polarizer 15 disposed on the imaging device 13 side of the retarder 3. The imaging device 13 acquires an image of the light transmitted through the polarizer 15.

When the irradiation light from the light source 14 is transmitted through the substrate sheet 4a, which has low transparency, the transmitted light undergoes diffraction due to, for example, refraction and diffuse reflection. That is, even though the light-shielding layer 4 is formed on the imaging device 13 side of the substrate sheet 4a, the transmitted light is wrapped around the backside of the light-shielding layer 4, thus reaching the retarder 3 without being blocked by the light-shielding layer 4.

In addition, because the polarizer 15 polarizes the irradiation light from the light source 14, the light reaches the imaging device 13 through either the right-eye-image display portions 3a or the left-eye-image display portions 3b of the retarder 3 while being blocked by the other display portions.

Thus, the polarizer 15 switches between transmission and blocking of light separately in the right-eye-image display portions 3a and the lyophilic regions 18a. If only switching is intended, it is possible to dispose the polarizer 15 on the light source 14 side, as in the first example described above. If the polarizer 2 is disposed on the light source 14 side, however, the light transmitted through the substrate sheet 4a may be less easily diffracted because the irradiation light from the light source 14 is polarized when transmitted through the polarizer 15. The polarizer 15 is therefore preferably disposed not on the light source 14 side but on the imaging device 13 side.

The imaging device 13, reached by the light transmitted through the substrate sheet 4a, the retarder 3, and the polarizer 15, has a bifocal depth-switching mechanism.

If the depth of focus is adjusted to the retarder 3, the boundaries between the right-eye-image display portions 3a and the left-eye-image display portions 3b of the retarder 3 are clearly recognized on the basis of the imaging results from the imaging device 13 because they are obtained from the light transmitted through the polarizer 15 with the retarder 3 in focus.

On the other hand, if the depth of focus is adjusted to the light-shielding layer 4, the positions of the edges of the light-shielding layer 4 are clearly recognized on the basis of the imaging results from the imaging device 13 because they are obtained from the diffracted light with the light-shielding layer 4 in focus.

These imaging results are stored in a storage device included in or accessible to the positioning apparatus.

Thus, the positioning apparatus can position the light-shielding layer 4 and the retarder 3 relative to each other on the basis of the stored results, that is, the imaging results obtained by focusing the imaging device 13 on the light-shielding layer 4 and the imaging results obtained by focusing the imaging device 13 on the retarder 3. Specifically, it is possible to move at least one of the upper seat 11 and the lower seat 12 so that the positions of the boundaries between the right-eye-image display portions 3a and the left-eye-image display portions 3b of the retarder 3 agree with those of the centers of the lines of the light-shielding layer 4 in the width direction.

Thus, in the positioning step described above, the substrate sheet 4a on which the light-shielding layer 4 is formed is disposed on the light source 14 side, and the retarder 3 is disposed on the imaging device 13 side. This allows planar positioning of the retarder 3 and the light-shielding layer 4 relative to each other without the effect of the low transparency of the substrate sheet 4a. For example, if the imaging device 13 used is a camera including an optical system with a magnification of about 60 times, accurate positioning can be performed within a short period of time with respect to a marking line added to the camera by bifocal depth switching for the retarder 3 and the light-shielding layer 4. Specifically, for example, the positioning accuracy can be improved from a variation of about −50 to +80 μm, which is typical in the related art, to half that variation, namely, about −10 to +40 μm. This allows planar positioning of the retarder 3 and the light-shielding layer 4 relative to each other with improved positioning accuracy.

### 2-4. Bonding Step

After the planar positioning of the image display panel 1, the retarder 3, and the polarizer 2 on which the light-shielding layer 4 is provided relative to each other, the bonding step is carried out to bond them together while maintaining the positioning thereof.

The bonding step includes a first bonding step of bonding together the image display panel 1 and the polarizer 2 on which the light-shielding layer 4 is provided with the first bonding agent layer 5 therebetween and a second bonding step of bonding together the polarizer 2 on which the light-shielding layer 4 is provided and the retarder 3 with the second bonding agent layer 7 therebetween.

Although either the first bonding step or the second bonding step may be carried out earlier, the case where the first second bonding step is carried out after the second bonding step will be described below as an example.

### 2-4-1. Second Bonding Step

The polarizer 2 on which the light-shielding layer 4 is provided and the retarder 3 are bonded together with the second bonding agent layer 7 therebetween. The second bonding agent layer 7 is provided over the entire region between the surface of the polarizer 2 on which the light-shielding layer 4 is not provided and the surface of the retarder 3 on which the right-eye-image display portions 3a and the left-eye-image display portions 3b are formed.

As with the first bonding agent layer 5, for the reason described later, the second bonding agent layer 7 may be formed of a transparent gelatinous acrylic tackiness agent and have a thickness of 25 to 100 μm. In addition, the hardness of the tackiness agent may be more than 0 pN and not more than 350,000 pN, and the holding force after bonding may be 8 to 20 N/20 mm at 40° C.

In addition, as with the first bonding agent layer 5, the second bonding agent layer 7 may be formed of a transparent gelatinous acrylic tackiness agent with a storage stiffness of more than 0 Pa and not more than 70,000 Pa and a loss stiffness of more than 0 Pa and not more than 20,000 Pa at 30° C. to 70° C. and with a creep rate of 0.3 mm or less, for the reason described later.

In the second bonding step, additionally, the antireflection film 8 is bonded to the retarder 3 with the third bonding agent layer 9 therebetween.

### 2-4-2. First Bonding Step

After the laminate including the light-shielding layer 4, the polarizer 2, and the retarder 3 is formed in the second bonding step described above, the laminate and the image display panel 1 are bonded together with the first bonding agent layer 5 therebetween.

For the first exemplary structure described above, the first bonding agent layer 5 is disposed between the image display panel 1 and the surface of the polarizer 2 on which the light-shielding layer 4 is provided so as to be excluded between the top surface of the light-shielding layer 4 and the image display panel 1. Specifically, the first bonding agent layer 5 is disposed on the surface of the polarizer 2 in the regions where the light-shielding layer 4 is not provided and therefore light is transmitted, so as to fill the grooves formed by the light-shielding layer 4.

On the other hand, the first bonding agent layer 5 is not disposed between the image display panel 1 and the top surface of the light-shielding layer 4. After the image display panel 1 and the laminate including the polarizer 2 are bonded together, the air layers 6, that is, spaces not filled with the first bonding agent layer 5, are formed between the image display panel 1 and the top surface of the light-shielding layer 4.

The first bonding agent layer 5, disposed so as to be excluded between the image display panel 1 and the top surface of the light-shielding layer 4, preferably satisfy the conditions described below.

The first bonding agent layer 5, which is disposed in the regions where light is transmitted, is preferably formed of a material that has no adverse effect on optical properties between the image display panel 1 and the polarizer 2 after bonding. Specifically, the first bonding agent layer 5 is formed of a transparent gelatinous acrylic tackiness agent.

In addition, if the first bonding agent layer 5 is extremely thin, it may be difficult to ensure the homogeneity thereof. For example, if the surface of the image display panel 1 to be bonded lacks flatness due to waviness, it may be difficult to absorb such waviness. For example, given that the light-shielding layer 4 is provided by transfer in the light-shielding-layer providing step, the thickness of the first bonding agent layer 5 is preferably at least larger than the height of the ridges formed by the light-shielding layer 4. If the first bonding agent layer 5 is extremely thick, however, it may have an adverse effect on optical properties, such as a decrease in transmittance, and also increases the risk of intrusion of foreign matter such as bubbles. Accordingly, the first bonding agent layer 5 has a thickness of 25 to 100 μm.

In addition, an extremely hard tackiness agent is undesirable as the material of the first bonding agent layer 5 because it may impair, for example, the function as a buffer between the image display panel 1 and the polarizer 2 and the function of filling the grooves formed by the light-shielding layer 4.

If the first bonding agent layer 5 has an extremely low holding force after bonding, it may be difficult to maintain the planar positioning of the image display panel 1 and the polarizer 2 relative to each other. A first bonding agent layer 5 with an extremely high holding force after bonding is also undesirable because it may be difficult to separate the portions bonded with the first bonding agent layer 5 and bond them together again when, for example, some problem occurs.

Accordingly, the hardness of the tackiness agent used for the first bonding agent layer 5 and the holding force after bonding are adjusted as described below.

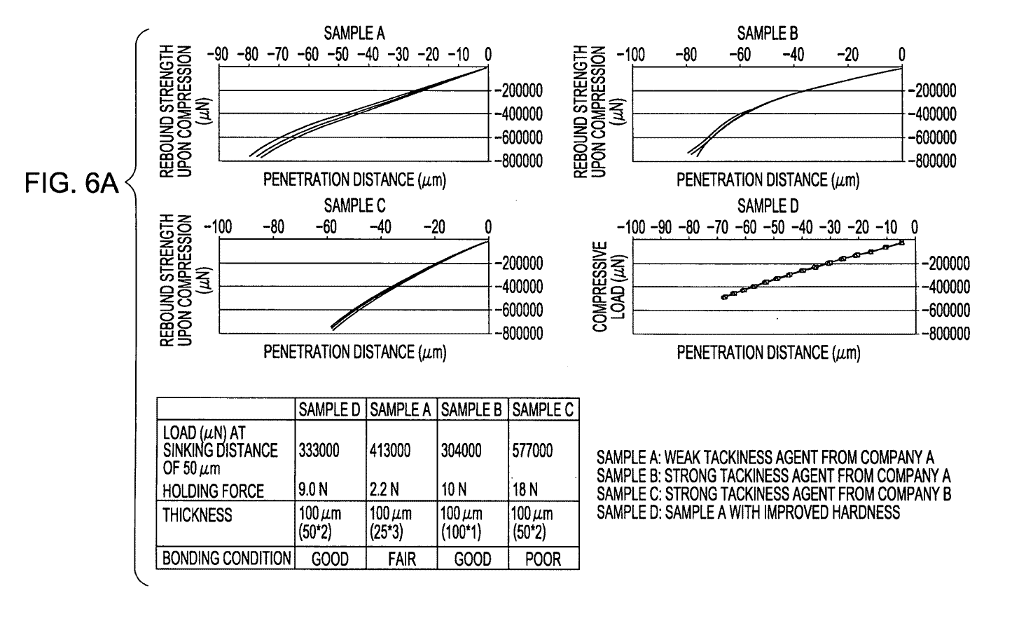

FIGS. 6A to 6C are graphs, a table, and diagrams showing a specific example of the relationship between the hardness of tackiness agents and the holding force of tackiness agent layers.

FIG. 6A shows comparison results of the hardness of tackiness agents and the holding force of tackiness agent layers for several types of tackiness agent layers with a thickness of 100 μm.

As shown in FIG. 6B, the measure used for the hardness of tackiness agents is rebound strength upon compression (for example, when a tackiness agent layer 21 with a thickness of 100 μm sinks by 50 μm).

As shown in FIG. 6C, the measure used for the holding force (adhesion strength) of tackiness agent layers is the peel strength of a tackiness agent layer 23 with a width of 20 mm on a glass substrate 22.

As shown in FIG. 6A, the results of measurement and comparison of the hardness of tackiness agents and the holding force of tackiness agent layers under the above conditions demonstrate that a tackiness agent layer with a tackiness agent hardness of not more than 350,000 μN and a holding force after bonding of 8 to 20 N/20 mm at 40° C. can maintain accurate positioning without having defects such as bubbles and peeling over the entire bonded surface or showing a defective appearance.

Thus, the tackiness agent used for the first bonding agent layer 5 has a hardness of more than 0 pN and not more than 350,000 μN, and the holding force after bonding is 8 to 20 N/20 mm at 40° C.

In addition, the first bonding agent layer 5 may satisfy the conditions described below in addition to, or instead of, the conditions described above.

The first bonding agent layer 5, which is disposed in the regions where light is transmitted, is formed of a transparent gelatinous acrylic tackiness agent.

In addition, an extremely hard tackiness agent is undesirable as the material of the first bonding agent layer 5 because it may impair, for example, the function as a buffer between the image display panel 1 and the polarizer 2 and the function of filling the grooves formed by the light-shielding layer 4. Thus, a tackiness agent with low elasticity and high viscosity is preferred so as not to impair such functions.

In addition, if the first bonding agent layer 5 has an extremely low holding force after bonding, it may be difficult to maintain the planar positioning of the image display panel 1 and the polarizer 2 relative to each other. In particular, given that the stereoscopic image display is exposed to a high-temperature environment as described above for a certain period of time or more, it may be difficult to maintain the positioning unless the creep rate is low. A first bonding agent layer 5 with an extremely high holding force after bonding is also undesirable because it may be difficult to separate the portions bonded with the first bonding agent layer 5 and bond them together again when, for example, some problem occurs.

Accordingly, the elasticity, viscosity, and creep rate of the tackiness agent used for the first bonding agent layer 5 are adjusted as described below.

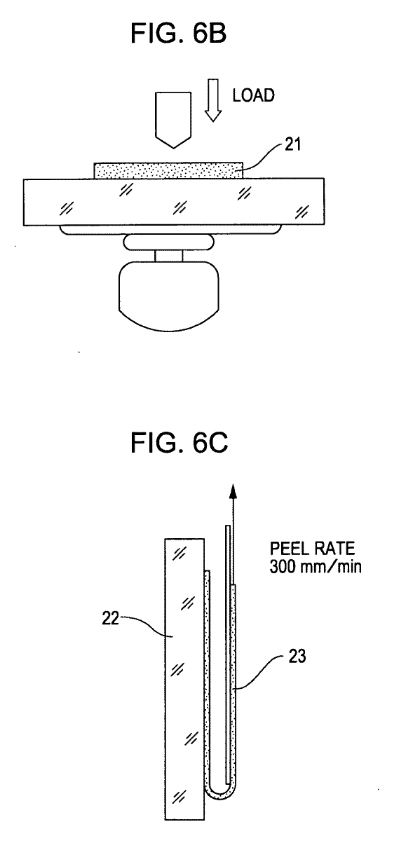

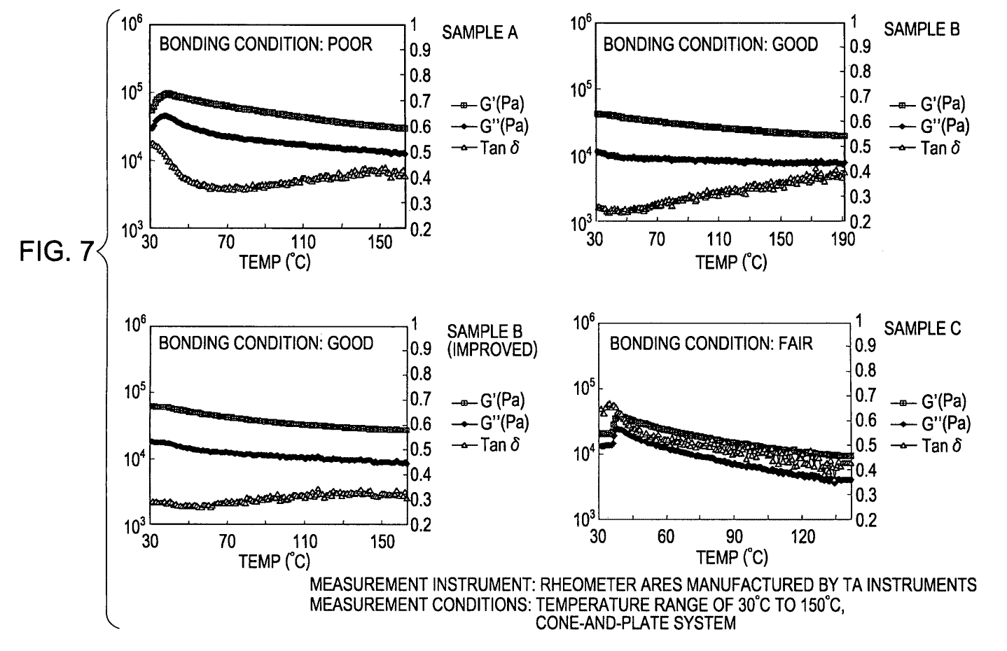

FIGS. 7, 8A, and 8B are a set of graphs, a table, and a diagram, respectively, showing a specific example of the elasticity, viscosity, and creep rate of tackiness agents.

FIG. 7 shows comparison results of the elasticity and viscosity of tackiness agents for several types of tackiness agent layers.

FIG. 8A shows comparison results of the creep force of the tackiness agent layers. As shown in FIG. 8B, the measure used for the creep force (adhesion strength) of the tackiness agent layers is displacement (mm) under a load of 1 kg at 80° c. after one hour.

As shown in FIGS. 7, 8A, and 8B, the results of measurement and comparison of the elasticity, viscosity, and creep rate of the tackiness agents under the above conditions demonstrate that a tackiness agent layer with a storage stiffness (equivalent to elasticity) of more than 0 Pa and not more than 70,000 Pa and a loss stiffness (equivalent to viscosity) of more than 0 Pa and not more than 20,000 Pa at 30° C. to 70° C. and with a creep rate of 0.3 mm or less can maintain accurate positioning without showing a defective appearance while covering the ridges and grooves formed by the light-shielding layer 4 so as to follow the shape thereof over the entire bonded surface.

Thus, the tackiness agent used for the first bonding agent layer 5 has a storage stiffness of more than 0 Pa and not more than 70,000 Pa and a loss stiffness of more than 0 Pa and not more than 20,000 Pa at 30° C. to 70° C. Satisfying these conditions allows the first bonding agent layer 5 to have a creep rate of 0.3 mm or less.

Although the first exemplary structure has been described here as an example, the first and second bonding steps may be carried out for the second exemplary structure in the same manner except for the regions where the first bonding agent layer 5 is provided.

For either the first exemplary structure or the second exemplary structure, the first bonding agent layer 5 used in the first bonding step and the second bonding agent layer 7 used in the second bonding step may be formed of a tackiness agent or adhesive other than those described above.

### 2-4-3. Pressing in Bonding Step

In the bonding of the image display panel 1, the polarizer 2, the retarder 3, and the light-shielding layer 4 in the first or second bonding step, the possibility of intrusion of, for example, minute bubbles is increased with increasing panel size. In addition, it may be difficult to maintain high profile precision for the image display panel 1, the retarder 3, or the top surface of the light-shielding layer 4. This increases the possibility of the surface to be bonded lacking flatness due to waviness and may therefore result in formation of local gaps and variations in the adhesion and distance between the components.

Thus, the image display panel 1, the polarizer 2, the retarder 3, and the light-shielding layer 4 are bonded together while being pressed using a bonding roller.

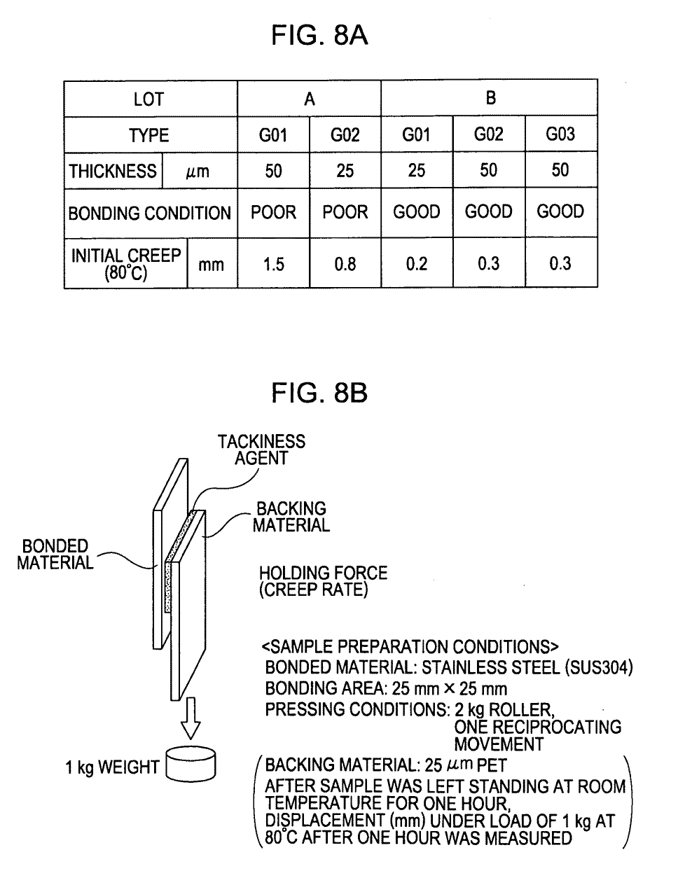

FIGS. 9A and 9B are a diagram and a graph, respectively, showing a specific example of press bonding using a bonding roller.

Although pressing in the first bonding step is illustrated in the example shown, it can also be applied to the second bonding step in the same manner.

In the first bonding step, as shown in FIG. 9A, the laminate including the polarizer 2 on which the light-shielding layer 4 is provided and the retarder 3 is bonded to the image display panel 1 with the first bonding agent layer 5 therebetween using a bonding roller 31 running from one end to the other end of the laminate (see the empty arrow in FIG. 9A) so as to press the top and bottom of the laminate in the lamination direction.

The bonding roller 31 runs at a speed within a predetermined range while pressing the laminate with a force within a predetermined range.

Specifically, as shown in FIG. 9B, the bonding roller 31 runs at a speed within an optimum condition area while pressing the laminate with a pressing force within the optimum condition area. If the pressing force is extremely small or the speed is extremely high, the possibility of intrusion of bubbles is increased.

The optimum condition area may be determined by an empirical rule based on experiments. The example shown illustrates the relationship between the pressing force and the running speed of the bonding roller 31 with the vertical position (clearance) of a support 32, described later, being 0.4 mm. The vertical position is appropriately adjusted depending on, for example, the thickness and size of the light-shielding layer 4, the polarizer 2, and the retarder, and naturally the relationship between the pressing force and the running speed varies accordingly.

In the press bonding using the bonding roller 31, the position of one edge of the laminate including the polarizer 2 is maintained so that the polarizer 2 on which the light-shielding layer 4 is provided forms a gap with the image display panel 1 on the side of the bonding position of the bonding roller 31 closer to the end of the laminate toward which the bonding roller 31 runs.

Specifically, as shown in FIG. 9A, the edge of the laminate including the polarizer 2 is supported by the support 32 so as to form a gap between the image display panel 1 and the laminate including the polarizer 2. The position of the edge of the laminate including the polarizer 2 is shifted as the bonding roller 31 runs. That is, as the bonding roller 31 approaches the support 32, the position of the support 32 is shifted so as to narrow the gap between the image display panel 1 and the laminate including the polarizer 2.

A detailed description of the mechanism for causing the bonding roller 31 to run and shifting the support 32 as the bonding roller 31 runs will be omitted here because it may be realized by a common technique.

In the press bonding using the bonding roller 31, the laminate including the polarizer 2 is bonded by sequentially pressing the laminate using the bonding roller 31 while warping the laminate such that the vertical position of the support 32 supporting one end of the laminate is shifted in association with the running speed of the bonding roller 31. This ensures that bubbles can escape from the end of the laminate toward which the bonding roller 31 runs, thus minimizing intrusion of dust and bubbles during the bonding of the image display panel 1 and the laminate.

In addition, the pressing force and the running speed of the bonding roller 31 are optimized so as to prevent intrusion of bubbles.

Accordingly, the laminate obtained by the above press bonding have no local gaps or variations in the adhesion or distance between the components because the bonding is performed under appropriate, uniform pressing conditions even if the components lack flatness due to waviness. In addition, intrusion of bubbles can be prevented even for larger panel sizes.

### 3. Advantages of Embodiment

Next, the advantages of the stereoscopic image display produced by the method described above will be described.

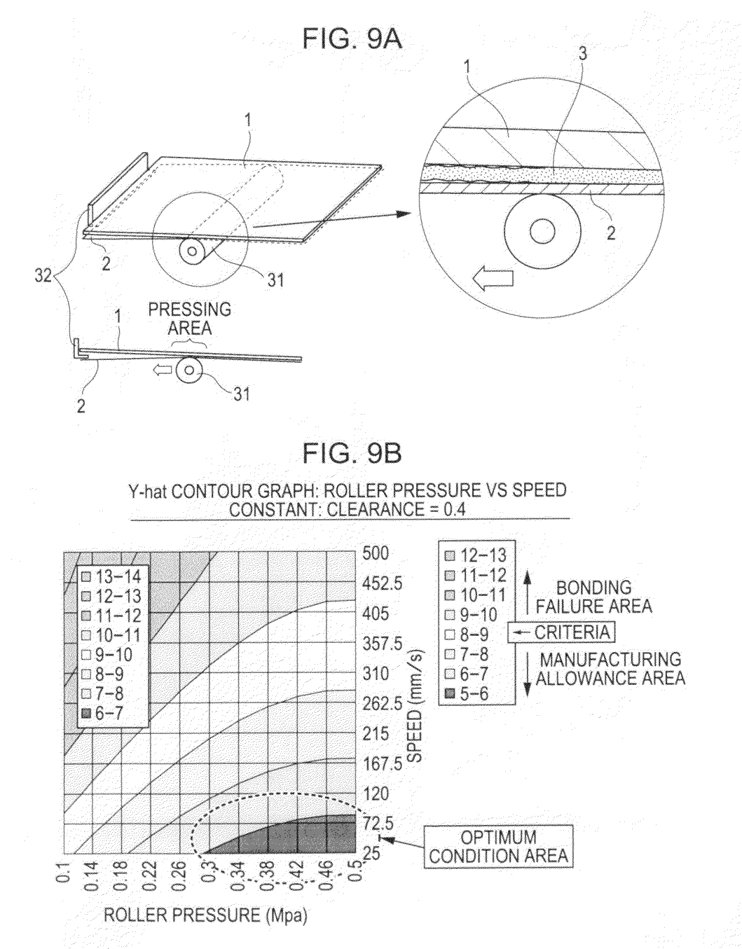

FIGS. 10A to 13 are diagrams and graphs showing the advantages of the stereoscopic image display according to the above embodiment.

As shown in FIG. 10A, the stereoscopic image display according to the above embodiment has the light-shielding layer 4 on the side of the polarizer 2 opposite the image display panel 1. For comparison, FIG. 10B shows a related-art product in which the light-shielding layer 4 is disposed on the image output side (farther away from the image display panel 1) of the polarizer 2, specifically, in which the light-shielding layer 4 is directly formed on the surface of the retarder 3.

Obviously, the light-shielding layer 4 is disposed closer to the image display panel 1 in the stereoscopic image display according to this embodiment than in the related-art product. The light-shielding layer 4 can therefore prevent crosstalk with a smaller pattern width for the same viewing angle than that of the related-art product. That is, if θ1=θ2 in FIGS. 10A and 10B, the relationship W1<W2 is established.

The case where the crosstalk rate is 7% will be described herein.

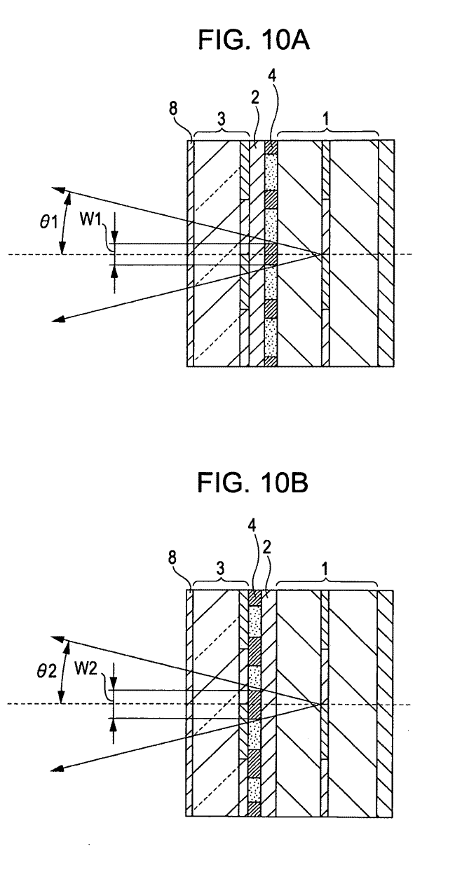

The crosstalk rate is usually defined as shown in FIG. 11. A crosstalk rate of 7% corresponds to a critical level at which most viewers can comfortably view a stereoscopically image without feeling tired.

As described above, if the light-shielding layer 4 is disposed closer to the image display panel 1 than is the polarizer 2, the pattern width of the light-shielding layer 4 can be made smaller than that of the related-art product. Accordingly, for the same crosstalk level as that of the related-art product (crosstalk rate of 7%), the luminance (aperture rate) determined by the area of the light-shielding layer 4 can be improved by about 65% to 70% of that of the related-art product.

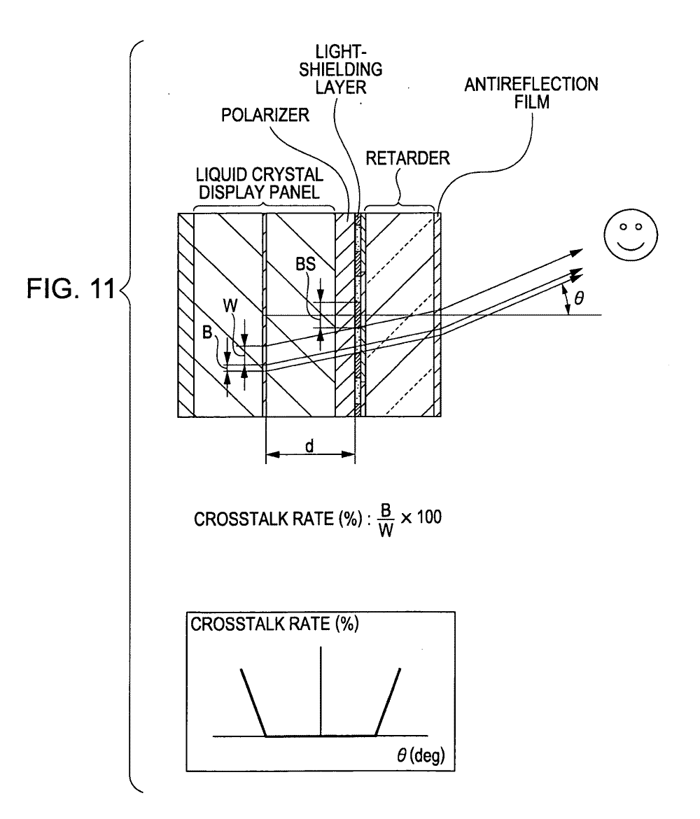

Specifically, as shown in FIG. 12, the screen luminance can be improved with respect to that of the related-art product. The relationship between the stereoscopic viewing angle and the screen luminance is linear, as in the example shown; it has been confirmed by experiment that the luminance can be improved to such an extent that a 40-inch screen can be viewed without problems.

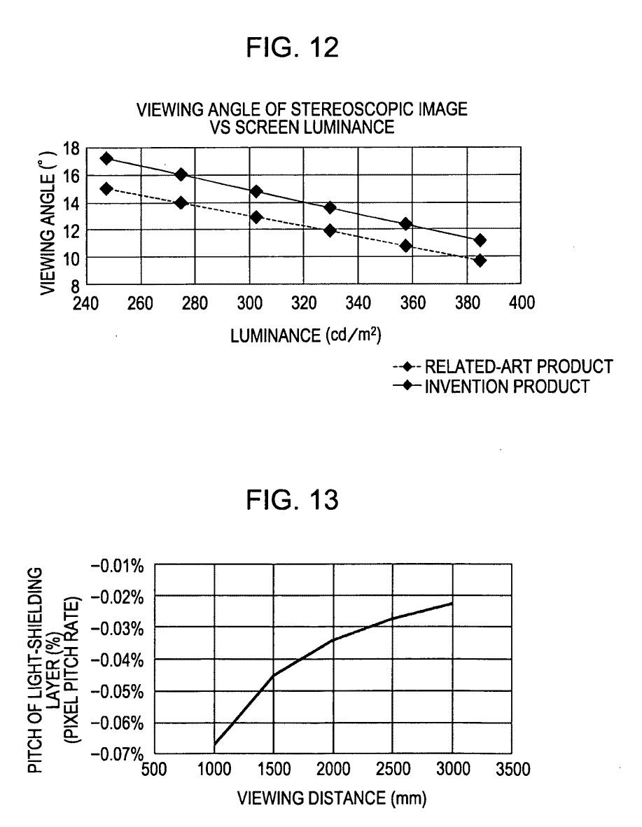

It has also been found that if the light-shielding layer 4 is disposed closer to the image display panel 1 than is the polarizer 2, the relationship between the viewing distance and the pitch of the light-shielding layer 4 (pixel pitch rate) is expressed as shown in FIG. 13.

Thus, the pattern width of the light-shielding layer 4 in the stereoscopic image display according to this embodiment can be made smaller than in the related-art product in which the light-shielding layer 4 is disposed on the image output side of the polarizer 2. The stereoscopic image display according to this embodiment can therefore prevent crosstalk while minimizing a decrease in the luminance of a displayed image. That is, the stereoscopic image display according to this embodiment is more successful than the related-art product in addressing the case where there is a tradeoff between the prevention of crosstalk and the prevention of the decrease in the luminance of a displayed image.

Although some preferred specific examples have been described in the above embodiment, the invention is not limited thereto; various modifications are permitted without departing from the spirit of the invention.

What is claimed is:

1. A stereoscopic image display comprising:
an image display panel that displays right-eye images and left-eye images in a regularly mixed pattern in a plane;
a retarder disposed on an image output side of the image display panel and including right-eye-image display portions corresponding to the right-eye images and left-eye-image display portions corresponding to the left-eye images, the right-eye-image display portions and the left-eye-image display portions causing polarization so that the right-eye images and the left-eye images have different polarization states;
a polarizer disposed between the image display panel and the retarder; and
a light-shielding layer disposed between the image display panel and the polarizer so as to correspond to regions including boundaries between the right-eye-image display portions and the left-eye-image display portions of the retarder.

2. The stereoscopic image display according to claim 1, wherein the light-shielding layer is disposed on a surface of the polarizer opposite the image display panel,
the stereoscopic image display further comprising a first bonding agent layer disposed between and bonding together the image display panel and the surface of the polarizer on which the light-shielding layer is disposed.

3. The stereoscopic image display according to claim 2, wherein the first bonding agent layer is disposed between the surface of the polarizer on which the light-shielding layer is disposed and the image display panel so as to be excluded between a top surface of the light-shielding layer and the image display panel.

4. The stereoscopic image display according to one of claims 1 to 3, further comprising a second bonding agent layer disposed between and bonding together the polarizer and the retarder.

5. The stereoscopic image display according to claim 4, wherein the first and second bonding agent layers are formed of a transparent gelatinous acrylic tackiness agent with a hardness of more than 0 μN and not more than 350,000 μN and have a thickness of 25 to 100 μm and a holding force after bonding of 8 to 20 N/20 mm at 40° C.

6. The stereoscopic image display according to claim 4, wherein the first and second bonding agent layers are formed of a transparent gelatinous acrylic tackiness agent with a storage stiffness of more than 0 Pa and not more than 70,000 Pa and a loss stiffness of more than 0 Pa and not more than 20,000 Pa at 30° C. to 70° C.

7. A method for producing a stereoscopic image display, comprising the steps of:
a second bonding step of bonding together a polarizer and a retarder with a second bonding agent layer therebetween, the polarizer being disposed so as to cover an image output side of an image display panel that displays right-eye images and left-eye images in a regularly mixed pattern in a plane, the retarder including right-eye-image display portions corresponding to the right-eye images and left-eye-image display portions corresponding to the left-eye images and being configured so that the right-eye-image display portions and the left-eye-image display portions achieve different polarization states;
a light-shielding-layer providing step, preceding the second bonding step, of providing a light-shielding layer on a surface of the polarizer opposite the image display panel so as to correspond only to regions including boundaries between the right-eye-image display portions and the left-eye-image display portions of the retarder; and
a first bonding step, following the light-shielding-layer providing step, of bonding together the image display panel and the surface of the polarizer on which the light-shielding layer is provided with a first bonding agent layer therebetween.

8. The method for producing a stereoscopic image display according to claim 7, wherein the light-shielding layer is provided on the surface of the polarizer in the light-shielding-layer providing step by forming the light-shielding layer on a substrate so as to be separable therefrom and transferring the light-shielding layer from the substrate onto the surface of the polarizer.

9. The method for producing a stereoscopic image display according to claim 7, wherein the first bonding agent layer is disposed between the surface of the polarizer on which the light-shielding layer is provided and the image display panel so as to be excluded between a top surface of the light-shielding layer and the image display panel in the first bonding step.

10. The method for producing a stereoscopic image display according to claim 7, wherein the first bonding agent layer used in the first bonding step is formed of a transparent gelatinous acrylic tackiness agent with a hardness of more than 0 μN and not more than 350,000 μN and has a thickness of 25 to 100 μm and a holding force after bonding of 8 to 20 N/20 mm at 40° C.

11. The method for producing a stereoscopic image display according to claim 7, wherein the first bonding agent layer used in the first bonding step is formed of a transparent gelatinous acrylic tackiness agent with a storage stiffness of more than 0 Pa and not more than 70,000 Pa and a loss stiffness of more than 0 Pa and not more than 20,000 Pa at 30° C. to 70° C.

12. The method for producing a stereoscopic image display according to claim 10 or 11, wherein
the bonding in the first bonding step is carried out by pressing the top and bottom of a laminate including the image display panel, the first bonding agent layer, the light-shielding layer, and the polarizer in a lamination direction with a force within a predetermined range using a bonding roller running from one end to the other end of the laminate at a speed within a predetermined range; and
the position of an edge of the polarizer at the other end of the laminate is maintained so that the polarizer and the light-shielding layer form a gap with the image display panel on the side of the bonding roller closer to the other end of the laminate and is shifted as the bonding roller runs.

13. The method for producing a stereoscopic image display according to claim 7, wherein the second bonding agent layer used in the second bonding step is formed of a transparent gelatinous acrylic tackiness agent with a hardness of more than 0 pN and not more than 350,000 pN and has a thickness of 25 to 100 μm and a holding force after bonding of 8 to 20 N/20 mm at 40° C.

14. The method for producing a stereoscopic image display according to claim 7, wherein the second bonding agent layer used in the second bonding step is formed of a transparent gelatinous acrylic tackiness agent with a storage stiffness of more than 0 Pa and not more than 70,000 Pa and a loss stiffness of more than 0 Pa and not more than 20,000 Pa at 30° C. to 70° C.

15. The method for producing a stereoscopic image display according to claim 13 or 14, wherein
the bonding in the second bonding step is carried out by pressing the top and bottom of a laminate including the image display panel, the first bonding agent layer, the light-shielding layer, the polarizer, the second bonding agent layer, and the retarder in a lamination direction with a force within a predetermined range using a bonding roller running from one end to the other end of the laminate at a speed within a predetermined range; and
the position of an edge of the retarder at the other end of the laminate is maintained so that the retarder forms a gap with the polarizer on the side of the bonding roller closer to the other end of the laminate and is shifted as the bonding roller runs.

16. The method for producing a stereoscopic image display according to claim 7, further comprising a positioning step, preceding the second bonding step, of positioning the retarder in a plane, the positioning step including recognizing the boundaries between the right-eye-image display portions and the left-eye-image display portions of the retarder by causing irradiation light from a light source disposed on one side of the retarder to reach the retarder through a polarizer disposed between the light source and the retarder and then acquiring an image of light transmitted through the retarder on an imaging device disposed on the other side of the retarder.

17. The method for producing a stereoscopic image display according to claim 7, further comprising a positioning step, preceding the first or second bonding step, of positioning the image display panel in a plane, the positioning step including recognizing the position of the image display panel in a plane by emitting irradiation light, having a sufficient intensity to be transmitted through the image display panel with the transmittance thereof minimized, from a light source disposed on one side of the image display panel and then acquiring an image of light transmitted through the image display panel on an imaging device disposed on the other side of the image display panel.

18. The method for producing a stereoscopic image display according to claim 7, further comprising an annealing step, preceding the second bonding step, of heating the retarder constituting part of the laminate at a predetermined temperature for a predetermined period of time.

19. The method for producing a stereoscopic image display according to claim 8, further comprising a positioning step, preceding the transfer of the light-shielding layer from the substrate in the light-shielding-layer providing step, of positioning the light-shielding layer and the retarder relative to each other, the positioning step including causing irradiation light from a light source to be sequentially transmitted through the substrate and the retarder and then to reach an imaging device through a polarizer disposed on the side of the retarder opposite the imaging device and then positioning the light-shielding layer and the retarder relative to each other on the basis of imaging results obtained with the imaging device focused on the light-shielding layer and imaging results obtained with the imaging device focused on the retarder.
